(19) United States
(12) Patent Application Publication
(10) Pub. No.: US 2003/0168106 A1
(43) Pub. Date: Sep. 11, 2003

(54) Dispensing apparatus for waste water treatment biocatalyst

(76) Inventors: Gary Morgan, Ft. Lauderdale, FL (US); Henry B. Schur, Ft. Lauderdale, FL (US)

Correspondence Address: Robert J. Van Der Wall, First Union Financial Center, Suite 5100, 200 South Biscayne Boulevard, Miami, FL, 33131-2310, US

(21) Appl. No.: 10/352,318

(22) Filed: Jan. 27, 2003

Related U.S. Application Data
(60) Provisional application No. 60/351,449, filed on Jan. 28, 2002.

(51) Int. Cl. F17D 3/00

(52) U.S. Cl. 137/551; 422/105; 422/119

(57) ABSTRACT

The invention is a gravity fed dispensing apparatus for waste water treatment biocatalyst. It uses a microprocessor to control an electromechanical solenoid value in order to dispense predefined amounts of liquid. It preferably comprises six major components. They are: 1) a printed circuit board, 2) a battery, 3) a solenoid valve, 4) a body having a base and a housing, 5) a reservoir, and 6) a hanger. The unit has the smallest footprint available for dispensing biocatalyst or other vital products into a waste water treatment system.

### CROSS REFERENCE TO RELATED APPLICATION

The present application continues from a provisional patent application serial No. 60/351,449 filed Jan. 28, 2002, and claims the filing date thereof as to the common subject matter.

### BACKGROUND OF THE INVENTION

1. Field of the Invention

The present invention generally relates to the field of waste water treatment. Specifically, it concerns an apparatus for dispensing a composition of matter in the form of a biocatalyst that stimulates metabolic and reproductive rates for most bacteria to greatly accelerate the process of waste water treatment.

2. Description of the Prior Art

The treatment of waste water in a conventional facility is a time consuming process. The result is that in order for any such facility to have meaningful capacity, the residence time of the waste water must be substantial in order for the bacteria to have sufficient time to achieve an acceptable effluent quality. This result in the construction of massive chemical storage tanks at great expense, which also constitute an eyesore in their communities.

### SUMMARY OF THE INVENTION

A principal object of the present invention is to provide an apparatus that automatically dispenses in a small space a composition of matter that greatly accelerates the process of waste water treatment.

Another principal object of the invention is to provide such an apparatus that is programmable to dispense the appropriate amount of such composition of matter.

A further principal object of the invention is to provide such an apparatus that includes a self contained power source that is rechargeable.

A related object of the invention is to reduce the cost of future waste water treatment facilities by minimizing the need for massive chemical storage tanks to achieve sufficient residence time for the bacteria to achieve an acceptable effluent quality.

Other objects and advantages will be apparent to those skilled in the art upon consideration of the following descriptions.

In accordance with a principal aspect of the invention, there is provided a gravity fed dispensing apparatus for waste water treatment biocatalyst, which uses a microprocessor to control an electromechanical solenoid value in order to dispense predefined amounts of liquid. It comprises 6 major components which are: 1) printed circuit board, 2) battery, 3) solenoid valve, 4) body, 5) reservoir, and 6) hanger. The unit has the smallest footprint available for dispensing biocatalyst or other vital products into a waste water treatment system.

While there is no intention to limit the invention thereby, an example of what the present invention achieves can be illustrated with the following dimensions: 9½″ high and 4½″ diameter, while the complete assembly utilizing a 2½ gallon supply measures only 22″ high×8″ wide 8″ deep, and will fit in a very confined space such as a manhole or lift station.

The inventive apparatus is fully adjustable to regulate dispensing flow rates and can make up to 24 injections in a 24 hour period. It is operated so there is no need to supply electrical hookups. Batteries will last a minimum of 6 months and are rechargeable. This unit can be fully adjustable using wireless technology. The unit can be adapted or customized to meet any dosing application protocols. The invention will be better understood upon reference to the following drawings and description.

### BRIEF DESCRIPTION OF DRAWINGS

FIG. 1 is a cross sectional view of the dispenser portion of the inventive apparatus.

FIG. 2 is partially exploded perspective view of the dispenser portion of the inventive apparatus.

FIG. 3 is a perspective view of the entire assembled inventive apparatus including the dispenser, supply bottle, and hanger.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific functional details disclosed herein are not to be interpreted as limiting, but merely as a basis for the appended claims and as a representative basis for teaching one skilled in the art to variously employ the present invention in virtually any appropriate circumstance.

The invention is a gravity fed dispensing apparatus for waste water treatment biocatalyst. It uses a microprocessor to control an electromechanical solenoid value in order to dispense predefined amounts of liquid. It preferably comprises six major components. They are: 1) a printed circuit board, 2) a battery, 3) a solenoid valve, 4) a body having a base and a housing, 5) a reservoir, and 6) a hanger. The unit has the smallest footprint available for dispensing biocatalyst or other vital products into a waste water treatment system.

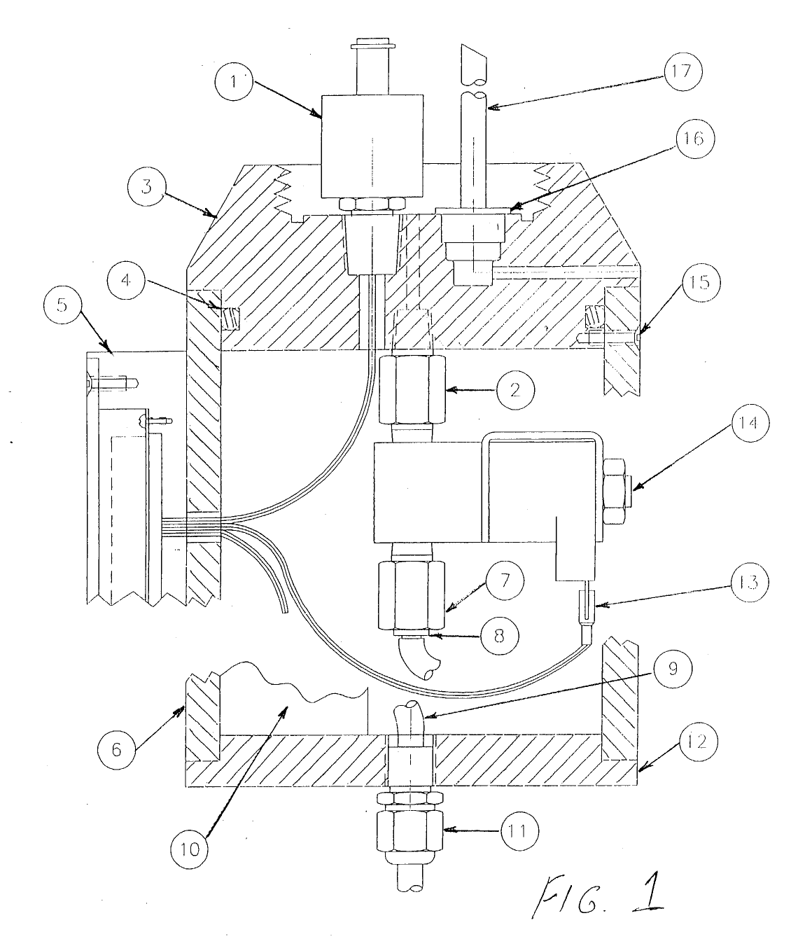

Referring now to the drawings, FIG. 1 is a cross sectional view of the dispenser portion of the inventive apparatus, and illustrates the major components of the dispenser in its housing 7. The inlet tube 1 projects into the supply container and the vent tube 17 allows for the supply bottle to be at atmospheric pressure at all times to prevent a vacuum from forming which will prevent the dispenser from functioning properly. The solenoid valve 14 is controlled by the electronic module located within its housing 5. The entire housing is scaled from environmental conditions by the use of o-ring 4. Power to energize the system comes from a battery pack 10 contained within the housing.

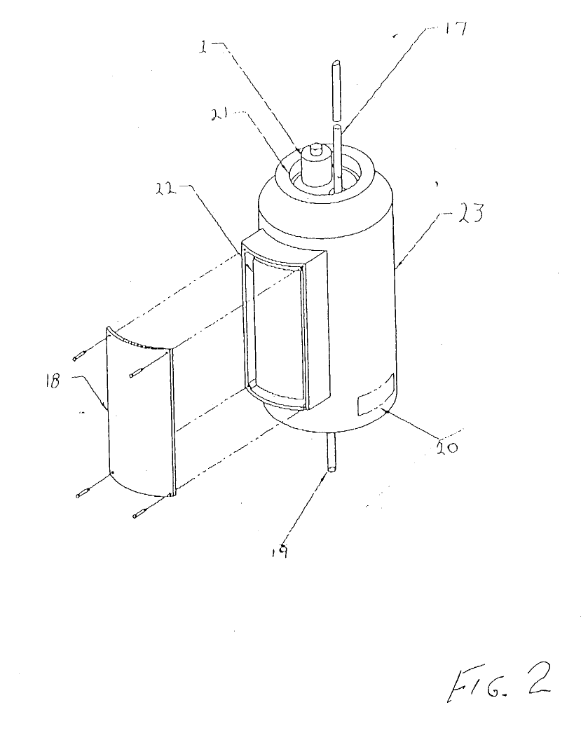

FIG. 2 illustrates the exterior view of the dispenser showing the housing 23 and the position of the inlet tube 1 and the outlet tube 19. The circuit board 22 and the electronic housing cover 18. The instruction for use label 20 is permanently attached to the side of the dispenser for user convenience.

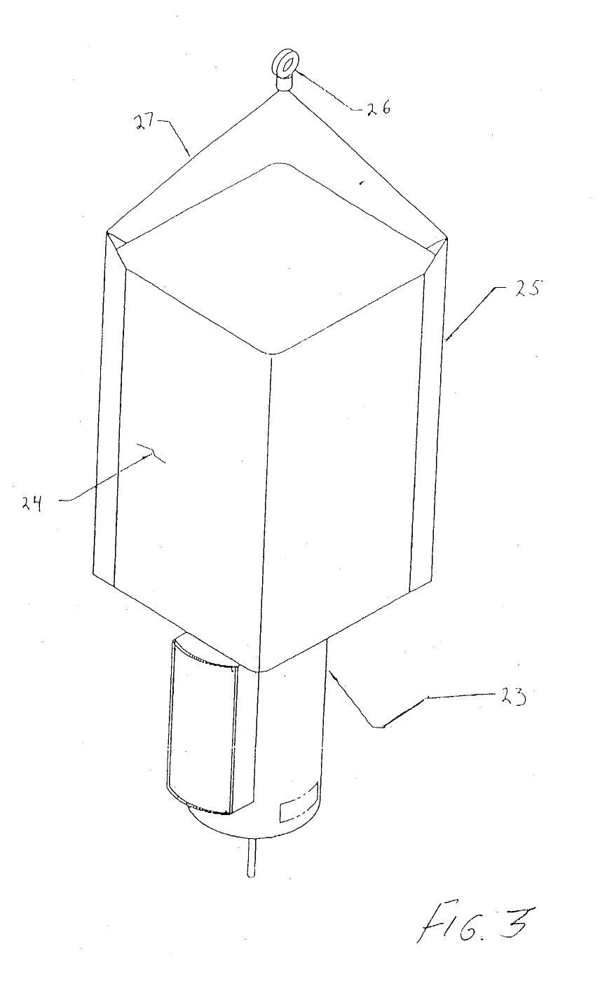

FIG. 3 shows the supply bottle 24 attached to the dispenser 23 with its hanger assembly 25, 26, 27 for suspension within the manhole.

Inlet tube 1 has attached to its exterior a float level switch that senses the level of the liquid in the supply bottle and can turn the electronics on or off at a predetermined level thus saving battery life and preventing the valve from “drying out” and thus having a potential fouling problem. The inlet tube then passes into a threaded coupling 2 to which is attached the solenoid valve 14 and thence the fluid passes out of the valve through fitting 7 using a quick insertion fitting 8 which allows for the servicing of the valve and then out of the dispenser via the outlet tube 19 that is attached to the housing with the fitting 11 shown. The solenoid 14 is powered by the battery pack 10 that has its electrical leads passing into the electronics housing 5 and onto the circuit board electronics 22. The electronics are encased in the housing 5 and covered by the watertight cover 8. O-ring 4 is used to seal the upper housing chamber 3 to the lower housing 6 and held securely by the screws 15. Valve 14 is attached to the controlling electronics via the spade fittings 13. Bottom 12 is solvent cemented to the housing 6 to establish a single unit housing that is water proof. The entire dispenser is attached to the supply container via the threads 21 cut in the dispenser head 3 which mate to the corresponding and sealing threads on the supply container 24 neck. The entire assembly of dispenser 23 and supply container 24 are supported and suspended by the hanger assembly which consists of a metal frame 25 in which the container nests and a bridle 27 and a swivel eye 26 for hanging on an installed hook or similar device.

The printed circuit board (Advanced Integration, Santa Ana, Calif.) uses a stand alone eight bit microprocessor which uses a 1.8 amp FET as a driver to control a solenoid valve (Kipp Industries, Farmingham, Conn.). Interface is provided by three tactile switches and can also be interfaced with an outside programmer via an RS245 port located on a control panel. This port can take commands from another computer or commands from the Internet via wireless communication. The microprocessor is capable of several functions. “On/off” commands to the solenoid valve can be programmed in a variety of ways. In its simplest form, the unit can be programmed to set “on” and “off” times in increments as small as milliseconds. The microprocessor contains a real time clock. This allows it to also be programmed to dispense at predetermined times of day. It can also be operated manually by pushing one of the momentary tactical switches. It will operate at any voltage in the range of 3-18 volts, and has a sleep mode, which automatically conserves battery power.

Power for the P.C. board and solenoid is provided by a 6 volt, 1.2 amp hour, nicad rechargeable battery (Tysonic, Allied Electronics). In sleep mode the P.C. board consumes 0.1 micro-amps.

The solenoid valve is a “poppet” type comprising a copper wound coil, pressure vessel, plunger with and elastomer seal, and sealing orifice. When energized, it consumes two watts of power.

The body comprises a base (Advanced Integration, Santa Ana, Calif.) and a housing (Keystone Filter, Hatfield, Pa.). Both are made of non-corrosive plastic such as machineable polyvinylchloride (PVC), or moldable glass filled polypropylene.

The base is used to connect the reservoir to the other components by utilizing the screw threads on the cap of the reservoir, which mates with the base. The base also houses the microprocessor and P.C. board assembly, the solenoid valve and the battery. The base provides a flow path from the reservoir to the solenoid valve. It also provides a “push to fit” type mounting for a vent tube, which allows air to vent into the reservoir. The vent tube is preferably a rigid piece of 3/8 inch diameter plastic. The “in” port of the solenoid connects to the base preferably using a standard 1/8 inch NPT plastic nipple and the out port connects to a flexible plastic dispensing tube using a standard fitting. The housing provides a watertight seal via an O-ring under compression sealing all the components from the outside environment. The dispensing tube passes through the bottom of the housing and is sealed using a standard Heyco “liquid tight” fitting.

The entire assembly, body and reservoir, is preferably suspended by use of a stainless steel framework or “hanger”. The hanger (Trailerman, Ft. Lauderdale, Fla.) encompasses the perimeter of the reservoir and uses the weight of the reservoir/body assembly to compress the open end of the framework around the reservoir. A stainless steel cable is attached at each end of the framework and then suspended at its center point to provide compression force on the reservoir and hold it in place. Relieving the suspended weight of the dispenser unit allows the framework to be easily detached.

These are three control switches used in setting up and operating the doser, each switch has a red light that confirms the command to the board. The procedure for setting dosing quantity is as follows:

1. Position the board so that the lights are below the buttons.

2. Press the left button once to activate unit, the light will blink once confirming activation.

3. Press the left button again to set Quantity to dispense; the light will blink once to confirm quantity activation.

4. Press the left button as many times as the quantity to set requires. For example, once for 0.25 oz., two times for 0.50 oz., three times for 0.75 oz. Upon completion, the light under the left switch will blink back the number of times the switch was pressed. Then all three lights will illuminate confirming the dosage quantity has been set. Immediately after proceed to step 5.

| Shot size | |
|---|---|
| Press left button | Ounce Dispensed |
| 1 time | .25 oz |
| 2 times | .50 oz |
| 3 times | .75 oz |
| 4 times | 1.00 oz |
| 5 times | 1.25 oz |
| 6 times | 1.50 oz |
| 7 times | 1.75 oz |
| 8 times | 2.00 oz |
| 9 times | 2.25 oz |
| 10 times | 2.50 oz |
| 11 times | 2.75 oz |
| 12 times | 3.0 oz |

The board is not limited to a maximum of 3.0 oz. shot size. Higher shot sizes may be inputted. Every time the button is pressed equals 0.25 ounce (1/4 ounce). Every 4 times the button is pressed equal 1.0 ounce. (Example: if 9 ounce shots are required the button should be pressed 36 times 9×4=36.)

The procedure for setting dosage frequency is as follows:

1. Press the left button ounce to active unit, the light will blink once confirming activation.

2. Press the right button once to set frequency, the light will blink once to confirm the unit is ready to accept frequency input.

3. Input the frequency the unit is to dispense. The left button inputs seconds, the center button minutes, the right button hours. (Example, if the unit is to dispense every 40 minutes press the center minutes button 40 times. If the frequency to set is every 1 hour and 10 minutes press the right hour button once and the center minute's button 10 times). The light under the button pressed will blink back the times the button was pressed, then all three lights will illuminate simultaneously confirming frequency set. Test Buttons: With the lights below the buttons the right button serves as a test button at all times. If the right button is depressed it will actuate the valve confirming valve operation.

The battery within the unit is fully rechargeable and comes fully charge to minimum of 6.0 volts. The valve requires 2 ohms to operate. With a full charge the battery will operate the unit dosing up to 48 times per day for a period of 6 months prior to recharge or replacement. Upon disconnecting the battery a minimum of one minute must be observed prior to reconnecting the battery to the unit due to diode current discharge. If battery is disconnected and immediately reconnected the unit may not function. If this occurs, simply 1) disconnect the battery from unit 2) touch a metal object to both male contacts of the boards battery plug. This action will discharge the board of any electrical charge and reactivate the board for operation.

A 12 inch rigid plastic breather tube is supplied with unit. Breather tube must be inserted into breather orifice (as shown below) prior to attaching unit to the 2.5 gallon container. Failure to do so will drain all the product in container through breather hole on the topside of unit head. Enough pressure must be applied while inserting breather tube to allow it penetrate through O-ring within breather tube orifice.

While the invention has been described, and disclosed in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the appended claims.

What is claimed is:

1. An apparatus for the dispensing of chemicals comprising:
a programmable valve;
a fluid reservoir in fluid communication with the valve; and a hanger.

2. The apparatus of claim 1 in which the valve is a solenoid valve.

3. The apparatus of claim 1 which further comprises a battery to power the programmable valve.

4. The apparatus of claim 3 in which the battery is rechargeable.

5. The apparatus of claim 1 which further comprises a body having a base and a housing.

6. The apparatus of claim 1 in which programming parameters include dispensing by time, date, and volume.

7. The apparatus of claim 1 that further comprises a wireless radio controller and a communication protocol.

8. The apparatus of claim 1 that further comprises an infrared signal device and a communication protocol.

9. The apparatus of claim 1 that further comprises electronic communication with sensors that control output based on external stimuli that include flow rates of a water stream, gas production in proximity to the apparatus, and other physical/chemical parameters.

10. The apparatus of claim 1 that further comprises a data logging device to record functionality of the apparatus for later interpretation and validation.

11. The apparatus of claim 1 which is adapted by compact structure for operation within small enclosures including a manhole, a wet well, and a sump pump well.

12. The apparatus of claim 1 that is a self-contained, integrated assembly whereby all the components attach to each other forming a continuous device.
